(19) United States
(12) Patent Application Publication
(10) Pub. No.: US 2025/0230909 A1
(43) Pub. Date: Jul. 17, 2025

(54) LUMINAIRE AND LUMINAIRE COMBINATION

(71) Applicant: ASIA LIGHTING CO., LTD, Dongguan (CN)

(72) Inventor: ZHENGXIONG CHEN, DONGGUAN (CN)

(21) Appl. No.: 18/631,074

(22) Filed: Apr. 10, 2024

Related U.S. Application Data
(63) Continuation of application No. PCT/CN2024/072727, filed on Jan. 17, 2024.

(51) Int. Cl. F21S 4/28; F21V 3/02; F21V 17/16; F21V 23/00

(52) U.S. Cl. CPC F21S 4/28; F21V 3/02; F21V 17/16; F21V 23/001

(57) ABSTRACT

A luminaire includes a light bar and a plastic light shell. The light shell includes a base and a light transmitting portion, the base and the light transmitting portion are configured as a one-piece and integral structure, the base and light transmitting portion cooperatively define a receiving cavity and an opening communicated to the receiving cavity. A mounting portion is formed in the base, the mounting portion includes a connecting portion and a snapping portion, the connecting portion and the snapping portion are configured as a one-piece and integral structure. The connecting portion is curved and is convex towards the base, the snapping portion is received in an inner cavity of the connecting portion, the snapping portion and the connecting portion cooperatively define a snapping slot, the light bar is snapped into the snapping slot.

### TECHNICAL FIELD

The present disclosure relates to a technical field of luminaires, and in particular to a luminaire and luminaire combination.

### BACKGROUND

A luminaire generally includes a base, a light transmitting portion, and a light bar disposed between the base and the light transmitting portion. When assembling the luminaire, an operator generally mounts the light bar on the base firstly, and subsequently, connects the light transmitting portion to the base.

Since the base and the light transmitting portion are configured as separated components, the operator may perform many operations to assemble the luminaire. An assembling efficiency is low. In addition, the base is generally made of aluminum. Therefore, electric leakage may occur.

### SUMMARY OF THE DISCLOSURE

The present disclosure provides a luminaire and luminaire combination. The luminaire may be assembled by performing a reduced number of operations. The assembling is convenient, and a risk of electric leakage is reduced.

In the present disclosure, the luminaire includes a light bar and a plastic light shell. The light shell includes a base and a light transmitting portion, where the base and the light transmitting portion are configured as a one-piece and integral structure. The base and light transmitting portion cooperatively define a receiving cavity and an opening communicated to the receiving cavity. A mounting portion is formed in the base. The mounting portion includes a connecting portion and a snapping portion, where the connecting portion and the snapping portion are configured as a one-piece and integral structure. The connecting portion is curved and is convex towards the base. The snapping portion is received in an inner cavity of the connecting portion. The snapping portion and the connecting portion cooperatively define a snapping slot. The light bar is snapped into the snapping slot.

In an embodiment, the connecting portion has two ends in a length direction of the light shell, and each of the two ends defines an avoidance opening. The avoidance opening allows a wire bundle of the light bar to pass through.

In an embodiment, each of two ends in the length direction of the light shell defines an opening.

In an embodiment, the luminaire further includes an adapter assembly. The adapter assembly includes at least one adapter base and at least one adapter. Each of the at least one adapter base covers one opening of the light shell. Each of the at least one adapter base defines a first wire hole, and the first wire hole is communicated with the receiving cavity of the light shell. The adapter base defines a mounting slot for a corresponding one of the at least one adapter. Each of the at least one adapter defines at least one second wire hole. The first wire hole is communicated with the at least one second wire hole.

In an embodiment, a first snapping portion is arranged at a bottom of the base. A second snapping portion is arranged at a bottom of the adapter base. The first snapping portion is snapped with the second snapping portion.

In an embodiment, the first snapping portion is a snapping notch, the second snapping portion is a snapping block. A thickness of the second snapping portion decreases along a direction extending towards the light shell.

In an embodiment, a third snapping portion is arranged on a side of the base. A fourth snapping portion is arranged on a side of the adapter base. The third snapping portion is snapped to the fourth snapping portion.

In an embodiment, a side of the adapter base facing the light shell is arranged with a support plate, and the support plate is arranged with a reinforcing rib.

In an embodiment, the adapter base is further arranged with at least one partition plate. The number of the at least one second wire hole is more than one. Each of the at least one partition plate is located between two adjacent second wire holes of the more than one second wire holes.

In an embodiment, the number of the at least one second wire hole is three, and the number of the at least one partition plate is two.

In an embodiment, each of the adapter base and the adapter is a light transmitting member.

In an embodiment, the luminaire combination includes at least two luminaires that are connected with each other. Each of the at least two luminaires is the luminaire as described in the above.

In an embodiment, the luminaire combination includes the adapter assembly. The adapter assembly includes the adapter base and the adapter. The adapter base of one of the at least two luminaires is connected to, via the adapter, the adapter base of another one of the at least two luminaires.

The luminaire and the luminaire combination of the present disclosure have following technical effects.

The present disclosure provides a luminaire and a luminaire combination. The luminaire includes the light bar and the plastic light shell. The light shell includes the base and the light transmitting portion, where the base and the light transmitting portion are configured as a one-piece and integral structure. The base and light transmitting portion cooperatively define the receiving cavity and the opening communicated to the receiving cavity. The mounting portion is formed in the base. The mounting portion includes the connecting portion and the snapping portion, where the connecting portion and the snapping portion are configured as a one-piece and integral structure. The connecting portion is curved and is convex towards the base. The snapping portion is received in an inner cavity of the connecting portion. The snapping portion and the connecting portion cooperatively define a snapping slot. The light bar is snapped into the snapping slot. When assembling the luminaire, the light bar is directly inserted into the snapping slot. In this way, a reduced number of operations are performed, the assembling is performed conveniently. In addition, since the connecting portion is curved and has a recess, light emitted from the light bar is focused towards the light transmitting portion. Brightness of the luminaire is improved. Each of the base, the light transmitting portion, and the mounting portion is made of plastic, and the base, the light transmitting portion, and the mounting portion are configured as a one-piece and integral structure, such that the risk of electric leakage is reduced.

### BRIEF DESCRIPTION OF THE DRAWINGS

The accompanying drawings are incorporated into the specification of the present disclosure and form a part of the specification. The accompanying drawings illustrate embodiments of the present disclosure. The accompanying drawings and the specification are used cooperatively to explain principles of the present disclosure.

In order to more clearly illustrate technical solutions in the embodiments of the present disclosure or in the related art, accompanying drawings to be used for describing the embodiments or the related art will be briefly described below. Apparently, any ordinary skilled person in the art may obtain other drawings based on the following drawings without making any creative work.

FIG. 1 is a structural schematic view of a luminaire according to one embodiment of the present disclosure.

FIG. 2 is a structural schematic view of a light shell of the luminaire shown in FIG. 1.

FIG. 3 is a structural schematic view I of an adaptor base of the luminaire shown in FIG. 1.

FIG. 4 is a structural schematic view II of the adaptor base of the luminaire shown in FIG. 1.

### REFERENCE NUMERALS IN THE DRAWINGS

1, light shell; 11, base; 111, first snapping portion; 112, third snapping portion; 12, light transmitting portion; 13, mounting portion; 131, connecting portion; 1311, avoidance opening; 132, snapping portion; 1321, snapping slot;
2, adapter assembly; 21, adapter base; 211, mounting slot; 212, second snapping portion; 213, fourth snapping portion; 214, support plate; 215, reinforcing rib; 216, partition plate; 22, adapter.

### DETAILED DESCRIPTION

In order to make purposes, technical solutions and advantages of the embodiments of the present disclosure clearer, the technical solutions in the embodiments of the present disclosure will be described clearly and completely in the following by referring to the accompanying drawings of the present disclosure. Apparently, the described embodiments are only a part of but not all of the embodiments of the present disclosure. All other embodiments, which are obtained by any ordinary skilled person in the art based on the embodiments in the present disclosure without making creative work, shall fall within the scope of the present disclosure.

The following disclosure provides various embodiments or examples used to achieve various structures of the present disclosure. In order to simplify the description of the present disclosure, components and configuration of certain examples are described below. Of course, the description illustrate examples only and is not to limit the present disclosure. Furthermore, the reference numerals and/or letters in various examples may be repetitively used. The repetition is for purposes of simplifying and clarifying the description and is not to indicate relationships between the various embodiments and/or configurations.

For ease of description, terms for describing spatial relationships are used herein to describe a relative positional relationship or a movement, as shown in the drawings, of one element or a feature with respect to another element or another feature. The terms include “in”, “out”, “inside”, “outside”, “under”, “below”, “above”, “above”, “front”, “rear”, and so on. The terms for describing spatial relationships are used to describe various orientations of a device when being in use or being operated, other than orientations depicted in the drawings. For example, when a position of the device in the drawings is reversed, or when an attitude or a motion state of the device in the drawings is changed, the orientational indications may be changed accordingly. For example, description of “a feature being below another element or feature” or “another element or feature being below the feature” may be defined as “a feature being above another element or feature” or “another element or feature being above the feature”. Therefore, in an example, a term “below” may mean that a feature is below or above another feature. The device may be additionally oriented (rotated 90 degrees or in other directions), and corresponding terms for describing the spatial relationships are used in the text accordingly.

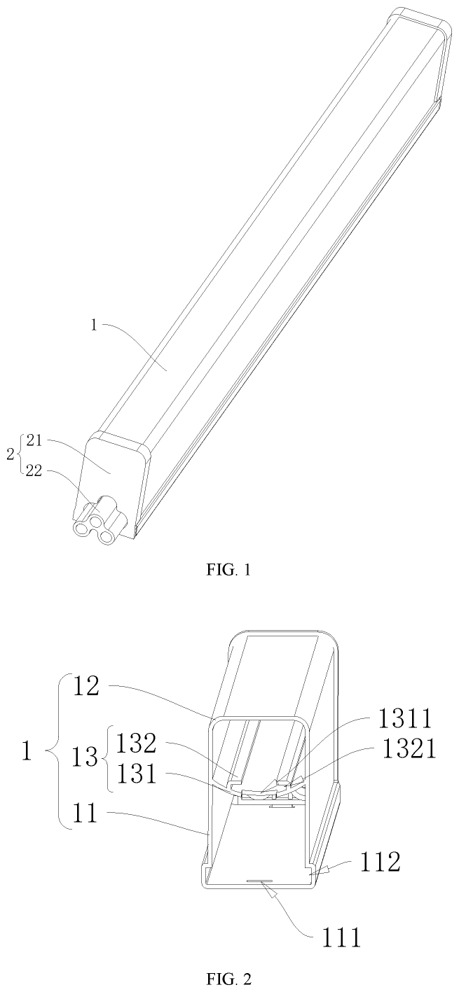

FIG. 1 is a structural schematic view of a luminaire according to one embodiment of the present disclosure, and FIG. 2 is a structural schematic view of a light shell of the luminaire shown in FIG. 1.

As shown in FIGS. 1 to 2, the present disclosure provides a luminaire. The luminaire includes a light bar and a plastic light shell 1. The light shell 1 includes a base 11 and a light transmitting portion 12, where the base 11 and the light transmitting portion 12 are configured as a one-piece and integral structure. The base 11 and light transmitting portion 12 cooperatively define a receiving cavity and an opening communicated to the receiving cavity. A mounting portion 13 is formed in the base 11 and is received in the receiving cavity. The mounting portion 13 includes a connecting portion 131 and a snapping portion 132, where the connecting portion 131 and the snapping portion 132 are configured as a one-piece and integral structure. The connecting portion 131 is curved and is convex towards the base 11. The snapping portion 132 is received in an inner cavity of the connecting portion 131. The snapping portion 132 and the connecting portion 131 cooperatively define a snapping slot 1321. The light bar is snapped into the snapping slot 1321.

To be understood that, the luminaire includes the light bar. The light bar is in a shape of an elongated strip. The light bar is arranged with a plurality of light beads. The plurality of light beads are spaced apart from each other and are arranged along a length direction of the light bar. The light shell 1 is in a shape of an elongated strip. The light shell 1 is made of plastic. The plastic is an insulating material, and therefore, the light shell 1 is prevented from having electric leakage.

The light shell 1 includes the base 11 and the light transmitting portion 12. Each of the base 11 and the light transmitting portion 12 is made of plastic. The base 11 and the light transmitting portion 12 are configured as a one-piece and integral structure. The light transmitting portion 12 may be curved or may be a rectangular-cubic structure having an inner cavity. The present disclosure does not limit the shape of the light transmitting portion 12.

The light transmitting portion 12 allows light to pass through. The base 11 blocks the light. In this way, light emitted from the luminaire is focused, and brightness of the light emitted from the luminaire is improved. In an example, the light transmitting portion 12 may be injection molded using a light transmitting material, such as polycarbonate (PC) and polymethylmethacrylate (PMMA). Further, the light transmitting portion 12 is configured as an embedding member and is injection molded into the base 11, and the light transmitting portion 12 and the base 11 are injection molded into the one-piece and integral structure. The base 11 is injection molded using a non-transmitting material, such as nylon PA and so on. Alternatively, the non-transmitting material is mixed into the light transmitting material. In another example, the base 11 and the light transmitting portion 12 are both made of the light transmitting material and are injection molded into the one-piece and integral structure. Further, a light-blocking paint is coated on an outer surface of the base 11.

The light shell 1 further includes the mounting portion 13. The mounting portion 13 and the base 11 are configured as a one-piece and integral structure. The mounting portion 13 is received in the receiving cavity. The mounting portion 13 includes the connecting portion 131 and the snapping portion 132, and the connecting portion 131 and the snapping portion 132 are configured as the one-piece and integral structure. The connecting portion 131 is curved and convex towards the base 11. The snapping portion 132 is disposed on a side of the connecting portion 131 facing towards the light transmitting portion 12. The luminaire includes two snapping portions 132. The two snapping portions 132 are spaced apart from each other and are arranged in a width direction of the light shell 1. The two snapping portions 132 and the connecting portion 131 cooperatively define the snapping slot 1321. The light bar is mounted in the snapping 1321, and in this way, the light bar is snapped in the light shell 1.

When assembling the luminaire, the light bar is directly inserted, from the opening, into the receiving cavity, and subsequently, the light bar is inserted into the snapping slot 1321. In this way, the light bar is connected with the mounting portion 13. Compared to the related art, the number of operations to assemble the luminaire is reduced, and the assembling is performed conveniently. Furthermore, since the connecting portion 131 is convex towards the base 11, light of the light bar is focused towards the light transmitting portion 12, and the brightness of the luminaire is improved.

Further, the mounting portion 13 is disposed at connection between the base 11 and the light transmitting portion 12, and a luminating effect of the luminaire is not affected.

In some embodiments, the connecting portion 131 has two ends along a length direction of the light shell 1, each of the two ends defines an avoidance opening 1311. The avoidance opening 1311 is defined to allow a wire harness of the light bar to pass through. The avoidance opening 1311 is defined to facilitate the wire harness to connect with the light bar. The wire harness is a wire, i.e., a zero wire, a fire wire, and a bottom wire. The wire harness is soldered to the light bar at the avoidance opening 1311 to supply power to the light bar and control the light bar to be switched on or off.

In some embodiments, each of two ends of the light shell 1 along the length direction defines an opening. The opening is defined to mount the light bar. In this way, the luminaire is connected to another luminaire, and a length of the luminaire is increased.

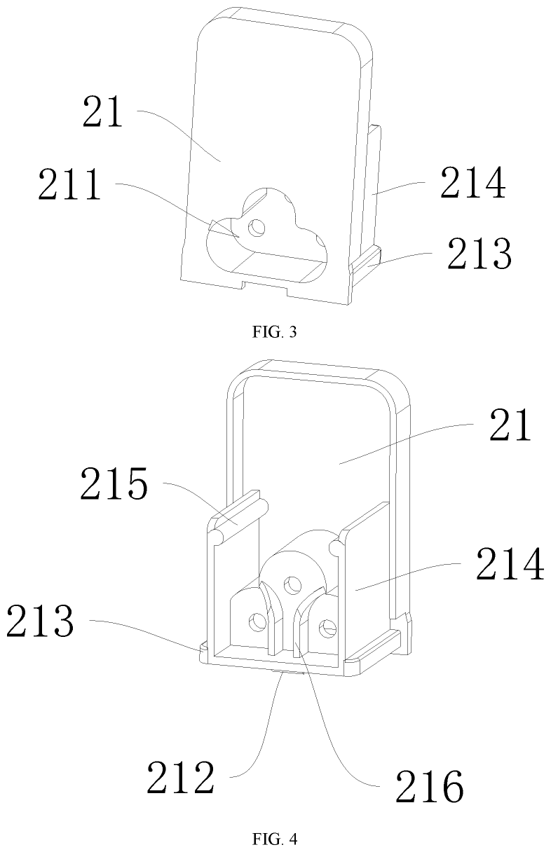

As shown in FIG. 1 and FIG. 3-FIG. 4, FIG. 3 is a structural schematic view I of an adaptor base of the luminaire shown in FIG. 1, and FIG. 4 is a structural schematic view II of the adaptor base of the luminaire shown in FIG. 1.

In some embodiments, the luminaire further includes an adapter assembly 2. The adapter assembly 2 includes at least one adapter base 21 and at least one adapter 22. Each of the at least one adapter base 21 covers the opening of the light shell 1. Each adapter base 21 defines a first wire hole. The first wire hole is communicated with the receiving cavity of the light shell 1. The adapter base 21 defines a mounting slot 211 adapted to a corresponding one of the at least one adapter 22. Each adapter 22 defines at least one second wire hole. The first wire hole is communicated with the second wire hole.

The adapter base 21 is adapted to the adapter 22. A length of the adapter 22 is equal to a length of two mounting slots 211. That is, when two luminaires are to be connected with each other, an end of the adapter 22 of one of the two luminaires is received in the mounting slot 211 of the adapter base 21 of the one of the two luminaires, and the other end of the adapter 22 is received in the mounting slot 211 of the adapter base 21 of the other one of the two luminaires. In this way, two adapter bases 21 of the two luminaires are connected with each other via the adapter 22.

When two luminaires are connected to each other, one adapter base 21 is connected to one of the two luminaires, and another adapter base 21 is connected to the other one of the two luminaires. The wire harness connected to the light bar extends out of the receiving cavity of one of the two luminaires and further extends into the first wire hole of the adapter base 21 of the one of the two luminaires. Subsequently, two ends of the adapter 22 are respectively inserted into mounting slots 211 of the two adapter bases 21 of the two luminaires. The second wire hole of the adapter 22 corresponds to and is communicated to the first wire hole of the adapter base of the other one of the two luminaires. In this way, the wire harness of one light bar extends, through the second wire hole and the first wire hole, into the receiving cavity of the other one of the two luminaires to connect to the light bar in the light shell 1 of the other one of the two luminaires. The two luminaires are connected to each other.

As shown in FIG. 1-FIG. 4, in some embodiments, a first snapping portion 111 is arranged at the bottom of the base 11. A second snapping portion 212 is arranged at a bottom of the adapter base 21. The first snapping portion 111 is configured to snap with the second snapping portion 212.

In an embodiment, the first snapping portion 111 is a snapping block, and the second snapping portion 212 is a snapping notch. When assembling the luminaire, the first snapping portion 111 is fixed to the snapping portion 212 by snapping. In this way, the bottom of the base 11 is snapped with the bottom of the adapter base 21, and therefore, the adapter base 21 is fixed to the light shell 1.

In some embodiments, the first snapping portion 111 is a snapping notch, the second snapping portion 212 is a snapping block. A thickness of the second snapping portion 212 is gradually reduced along a direction extending towards the light shell 1. When assembling the luminaire, the first snapping portion 111 is fixed to the second snapping portion 212 by snapping. Since the thickness of the second snapping portion 212 is gradually reduced along the direction extending towards the light shell 1, it is easier for the second snapping portion 212 to be received into the first snapping portion 111, and a chance that the second snapping portion 212 is disengaged from the first snapping portion 111 is reduced.

In some embodiments, a third snapping portion 112 is arranged on a side of the base 11, and a fourth snapping portion 213 is arranged on a side of the adapter base 21. The third snapping portion 112 is snapped to the fourth snapping portion 213.

The third snapping portion 112 is arranged on the side of the base 11. Two third snapping portions 112 are arranged on two opposite sides of the base 11 respectively. Two fourth snapping portions 213 are arranged on two opposite sides of the adapter base 21 respectively. When the third snapping portion 112 and the fourth snapping portion 213 are snapped with each other, the two sides of the base 11 and the two sides of the adapter base 21 are snapped with each other, the base 11 and the adapter base 21 are prevented from shaking, and connection between the base 11 and the adapter base 21 is improved.

In an embodiment, the third snapping portion 112 is a snapping notch and the fourth snapping portion 213 is a snapping block. When the fourth snapping portion 213 extends into the third snapping portion 112, the adapter base 21 is connected to the light shell 1.

In an embodiment, the third snapping portion 112 is a snapping block, and the fourth snapping portion 213 is a snapping notch. An opening of the snapping notch faces toward the mounting portion 13. When the third snapping portion 112 is inserted into the fourth snapping portion 213, the third snapping portion 112 is received in the receiving cavity, and the adapter base 21 is connected to the light shell 1.

In some embodiments, a support plate 214 is arranged on a side of the adapter base 21 facing the light shell 1. The support plate 214 is arranged with a reinforcing rib 215. The support plate 214 provides protect for an interior of the adapter base 21. When the adapter base 21 is being mounted to the light shell 1, the support plate 214 is inserted into the receiving cavity. The reinforcing rib 215 is arranged to improve strength of the support plate 214. The reinforcing rib 215 is cylindrical. The reinforcing rib 215 extends along a length direction of the adapter base 21. The reinforcing rib 215 is further configured to improve stability of connection between the adapter base 21 and the base 11.

In some embodiments, the adapter base 21 is further arranged with at least one partition plate 216. The number of the at least one second wire hole is more than one. Each of the at least one partition plate 216 is disposed between two adjacent second wire holes of the more than one second wire hole. The partition plate 216 is configured to prevent a plurality of wire harnesses from affecting each other, and therefore, safety of the luminaire is improved.

In an embodiment, the number of the at least one second wire hole is three, and the number of the at least one partition plate 216 is two. The two partition plates 216 separate the three second wire holes from each other. In this way, the fire wire, the zero wire, and the bottom wire of the wire harnesses are separated from each other and are prevented from affecting each other.

In some embodiments, the adapter base 21 and the adapter 22 are light transmitting members. The adapter base 21 and the adapter 22 are made of a light transmitting material PC. When two luminaires are connected to each other, the material of the adapter assembly 2 allows the connection at which the two luminaires are connected to each other to be light transmittable. In this way, the connection at which the two luminaires are connected to each other may not have dark shadows, and the luminating effect of the luminaires is improved.

The present disclosure further includes a luminaire combination including at least two luminaires that are connected to each other. Each of the at least two luminaires is the luminaire as described in any one of the above embodiments. The present disclosure does not limit the number of luminaires. The number of the at least two luminaires is two, three or more.

In some embodiments, the luminaire includes the adapter assembly 2. The adapter assembly 2 includes the adapter base 21 and the adapter 22. The adapter base 21 of one of the at least two luminaires is connected to, via the adapter 22, the adapter base 21 of the other one of the at least two luminaires.

When the two luminaires are connected to each other, two adapter bases 21 are connected to the ends of the two light shells 1 respectively. The wire harnesses connected to the light bar extends out of the receiving cavity and extends into the first wire hole of the adapter base 21. Further, two ends of the adapter 22 are respectively inserted into the mounting slots 211 of the two adapter bases 21 of the two luminaires. The second wire holes of the adapter 22 correspond to and are communicated with the first wire hole. The wire harness of the light bar of one of the two luminaires extends through the second wire hole and the first wire hole and extends into the receiving cavity of the other one of the two luminaires. Further, the wire harness is connected to wire harness in the light shell 1 of the other one of the two luminaires. In this way, the two luminaires are connected to each other.

It should be understood that the terms used herein are used only for the purpose of describing particular embodiments and are not to limit the present disclosure. Unless the context clearly indicates otherwise, a singular form “one”, “a”, and “the” may include plural forms. The term “include”, “comprise”, “contain”, and “have” are inclusive and specifies presence of the described feature, step, operation, element and/or component. The term does not preclude presence or addition of one or more other features, steps, operations, elements, components, and/or combinations thereof. The method steps, processes, and operations described herein are not required to be performed in a particular order as described or illustrated herein, unless the order is clearly indicated. It should also be understood that additional or alternative steps may be used.

Although the terms first, second, third, and so on, may be used to describe a plurality of elements, components, regions, layers and/or segments, the elements, components, regions, layers and/or segments shall not be limited by the terms. The terms are used only to distinguish one element, component, region, layer, or segment from another element, component, region, layer, or segment. Terms such as “first”, “second”, and other numerical terms are used herein do not imply an order or a sequence unless the context clearly indicates. Therefore, the first element, the first component, the first region, the first layer, or the first segment discussed herein may be referred to as a second element, a second component, a second region, a second layer, or a second segment without departing from teachings of the embodiments.

The above describes only specific embodiments of the present disclosure to enable any ordinary skilled person in the art to understand or achieve the present disclosure. Various modifications to the embodiments are apparent to any ordinary skilled person in the art. General principles defined herein may be realized in other embodiments without departing from the spirit or scope of the present disclosure. Accordingly, the present disclosure is not limited to the embodiments described herein, but is subject to the broadest possible scope consistent with the principles and novel features claimed herein.

What is claimed is:

1. A luminaire, comprising: a light bar and a plastic light shell, wherein,
the light shell comprises a base and a light transmitting portion, the base and the light transmitting portion are configured as a one-piece and integral structure, the base and light transmitting portion cooperatively define a receiving cavity and an opening communicated to the receiving cavity;
a mounting portion is formed in the base, the mounting portion comprises a connecting portion and a snapping portion, the connecting portion and the snapping portion are configured as a one-piece and integral structure;
the connecting portion is curved and is convex towards the base, the snapping portion is received in an inner cavity of the connecting portion, the snapping portion and the connecting portion cooperatively define a snapping slot, the light bar is snapped into the snapping slot.

2. The luminaire according to claim 1, wherein, the connecting portion has two ends in a length direction of the light shell, each of the two ends defines an avoidance opening, and the avoidance opening allows a wire bundle of the light bar to pass through.

3. The luminaire according to claim 1, wherein, each of two ends of the light shell, in the length direction, defines an opening.

4. The luminaire according to claim 3, wherein, the luminaire further comprises an adapter assembly;
the adapter assembly comprises at least one adapter base and at least one adapter, each of the at least one adapter base covers one opening of the light shell;
each of the at least one adapter base defines a first wire hole, the first wire hole is communicated with the receiving cavity of the light shell, each of the at least one adapter base defines a mounting slot for a corresponding one of the at least one adapter;
each of the at least one adapter defines at least one second wire hole, the first wire hole is communicated with the at least one second wire hole.

5. The luminaire according to claim 4, wherein, a first snapping portion is arranged at a bottom of the base, a second snapping portion is arranged at a bottom of the adapter base, the first snapping portion is snapped with the second snapping portion.

6. The luminaire according to claim 5, wherein, the first snapping portion is a snapping notch, the second snapping portion is a snapping block, a thickness of the second snapping portion decreases along a direction extending towards the light shell.

7. The luminaire according to claim 4, wherein, a third snapping portion is arranged on a side of the base, a fourth snapping portion is arranged on a side of the adapter base, and the third snapping portion is snapped to the fourth snapping portion.

8. The luminaire according to claim 4, wherein, a side of the adapter base facing the light shell is arranged with a support plate, and the support plate is arranged with a reinforcing rib.

9. The luminaire according to claim 4, wherein, the adapter base is further arranged with at least one partition plate, the number of the at least one second wire hole is more than one, each of the at least one partition plate is located between two adjacent second wire holes of the more than one second wire holes.

10. The luminaire according to claim 9, wherein, the number of the at least one second wire hole is three, and the number of the at least one partition plate is two.

11. The luminaire according to claim 4, wherein, each of the adapter base and the adapter is a light transmitting member.

12. A luminaire combination, comprising at least two luminaires that are connected with each other, wherein,
each of the at least two luminaires comprises: a light bar and a plastic light shell;
the light shell comprises a base and a light transmitting portion, the base and the light transmitting portion are configured as a one-piece and integral structure, the base and light transmitting portion cooperatively define a receiving cavity and an opening communicated to the receiving cavity;
a mounting portion is formed in the base, the mounting portion comprises a connecting portion and a snapping portion, the connecting portion and the snapping portion are configured as a one-piece and integral structure;
the connecting portion is curved and is convex towards the base, the snapping portion is received in an inner cavity of the connecting portion, the snapping portion and the connecting portion cooperatively define a snapping slot, the light bar is snapped into the snapping slot.

13. The luminaire combination according to claim 12, wherein, the luminaire combination includes an adapter assembly, the adapter assembly comprises at least one adapter base and an adapter;
one of the at least one adapter base for one of the at least two luminaires is connected to, via the adapter, another one of the at least one adapter base for another one of the at least two luminaires.
